(19) United States
(12) Patent Application Publication
(10) Pub. No.: US 2011/0229126 A1
(43) Pub. Date: Sep. 22, 2011

(54) Automatic Adjustment of Optical Bandwidth Based on Client Layer Needs

(75) Inventor: Ornan Gerstel, Herzliya (IL)

(73) Assignee: CISCO TECHNOLOGY, INC., San Jose, CA (US)

(21) Appl. No.: 12/726,584

(22) Filed: Mar. 18, 2010

(51) Int. Cl. H04B 17/00; H04J 3/22

(52) U.S. Cl. 398/25; 370/468

(57) ABSTRACT

At a cross-connect device coupled to a router, utilization of a logical interface of the router is monitored using generally available mechanisms on the router without requiring purpose-built mechanisms. Capacity of interface resources to the logical interface used at the router is adjusted depending on the utilization.

### TECHNICAL FIELD

The present disclosure relates to networks, and more particularly to improving the utilization of optical network equipment.

### BACKGROUND

In the field of networked communication and network transport devices, there is a growing interest to add intelligence and dynamic behavior to an optical layer of the network. For example, equipment in the optical layer can adjust a connection according to bandwidth needs. Obtaining knowledge as to utilization of router links in an optical network can allow for adjustments to be made to more economically use available optical bandwidth in the network. Making an adjustment in link capacity at an optical router can accommodate nearly all types of surges in utilization. However, the challenge is determining when and how to make that adjustment with minimal changes to the existing network equipment.

### BRIEF DESCRIPTION OF THE DRAWINGS

FIG. 1 is an example of a block diagram showing a cross-connect device configured to monitor utilization of a logical interface for a router and to adjust capacity for interface resources for the logical interface.

FIG. 2 is an example of a block diagram showing a cross-connect device configured to monitor utilization of the logical interface using information received via a network management interface with the router, according to one embodiment.

FIG. 3 is an example of a block diagram of a cross-connect device configured to monitor utilization of the logical interface by analyzing packets in the logical interface, according to one embodiment.

FIG. 4 is an example of a block diagram of a cross-connect device configured to monitor utilization of the logical interface for the router.

FIG. 5 is an example of a flow chart generally depicting a utilization and interface adjustment process performed by the cross-connect device.

FIG. 6 is an example of a flow chart depicting a technique to monitor utilization of a link bundle for the cross-connect device configured according to FIG. 2.

FIG. 7 is an example of a flow chart depicting a technique to monitor utilization for the cross-connect device configured according to FIG. 3.

FIG. 8 is an example of a flow chart depicting a process to evaluate the utilization in order to adjust the interface resources used by the router based the utilization.

FIG. 9 is an example of a block diagram showing interconnection of multiple cross-connect devices and available link interfaces.

FIG. 10 is a diagram similar to FIG. 9 and illustrating an example utilization scenario prior to adjusting the number of link interfaces used for a connection served by two routers.

FIG. 11 is a diagram similar to FIG. 10 and illustrating the example utilization scenario after adjusting the number of link interfaces used for a connection served by two routers.

### DESCRIPTION OF EXAMPLE EMBODIMENTS

Overview

A mechanism is provided herein for an optical device, such as a cross-connect (XC) device, to discover the bandwidth needs at the client layer, allowing the optical device to add or remove bandwidth interface capability with respect to a link bundle without requiring explicit collaboration from the client device. The cross-connect device modifies bandwidth on demand without requiring explicit support from the client device, such as a router.

Accordingly, at a cross-connect device configured to be coupled to a router, utilization of a logical interface of the router is monitored. Capacity of interface resources to the logical interface at the router is adjusted depending on the utilization. The logical interface may comprise a link bundle, and in which case adjusting capacity may involve adding for use or removing from use a physical link interface for the link bundle depending on the utilization. Alternatively, the logical interface may comprise a virtual interface which is a portion of a physical link interface, and in which case adjusting comprises adjusting bandwidth for a physical link interface for the virtual interface based on the utilization.

### Example Embodiments

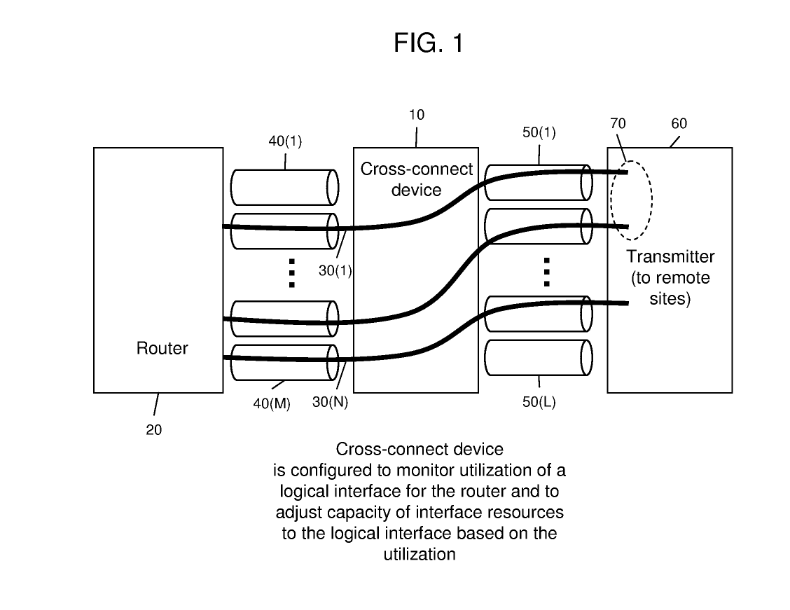

Reference is first made to FIG. 1. FIG. 1 illustrates an arrangement in an optical network comprising a cross-connect device 10 and an optical router 20, referred to herein simply as a router. The router 20 may be a “core” router in one example. A router is a router designed to operate in the Internet backbone, or core. To fulfill this role, a router supports multiple telecommunications interfaces of the highest speed in use in the core Internet and forwards packets at full speed on all of them. However, the router 20 may also be an edge router that sits at the edge of a backbone network and in general the router 20 may be any packet forwarding device.

The router 20 transmits and receives optical signals on optical links shown at reference numbers 30(1)-30(N). The cross-connect device 10 switches signals on these optical links from link interfaces 40(1)-40(M) of the router 20 to link interfaces 50(1)-50(L) that are connected to a transmitter module 60. The link interfaces 40(1)-40(M) are referred to herein as interface resources at the router 20. The transmitter module 60 transmits optical signals for each optical link to a remote site where a router and cross-connect device are provided in a configuration similar to that shown in FIG. 1. The optical links 30(1)-30(N) are grouped into bundles, called link bundles, an example of which is shown at reference numeral 70.

According to the techniques described herein, a device, such as the cross-connect device 10, is configured to monitor utilization of a link bundle for a router 20 and to dynamically and automatically adjust the capacity (i.e., bandwidth) of a router link or the number of the plurality of interfaces 40(1)-40(N) at the router 20 used for a link bundle, e.g., link bundle 70, based on the utilization determined for the link bundle. The term “logical interface” is meant to refer to either a link bundle as well as a virtual interface which is a portion or fraction of a physical link interface, e.g., an optical link. Thus, depending on a configuration of a router, the logical interface may comprise a link bundle consisting of a plurality of optical links, and in other circumstances it may comprise a virtual interface. As explained above and in further detail hereinafter, when the logical interface comprises a link bundle, adjusting capacity comprises adding for use or removing from use a physical link interface for the link bundle depending on the utilization. When the logical interface comprises a virtual interface which is a portion of a physical link interface, adjusting comprises adjusting the bandwidth of a physical link interface for the virtual interface based on the utilization. In other words, a single logical interface is a single virtual interface when the logical interface requires less bandwidth than the capacity of an optical link, and a logical interface is a single link bundle when the logical interface requires a bandwidth that is larger than that of the optical link. In this way, the optical layer (e.g., the optical transport network cross-connect device) automatically discovers whether the router will require more bandwidth or whether it can free up optical bandwidth.

Two ways to monitor router utilization are described herein.

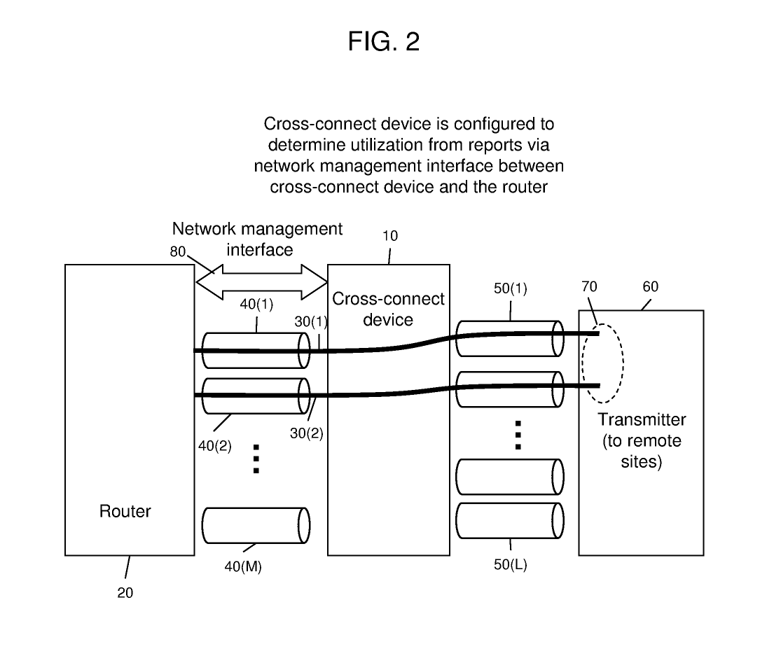

First, in FIG. 2, the cross-connect device 10, is configured to determine link bundle utilization at router 20 from reports it receives via a network management interface 80 between the cross-connect device 10 and the router 20. For example, the cross-connect device 10 receives bandwidth utilization statistics for the logical interface, e.g., each link in the link bundles of the router, where the bandwidth utilization statistics comprise one or more of number of packets transmitted, average size of a packet and total bandwidth consumed as well as the accumulated queue in the router. In the example diagram shown in FIG. 2, the interface 40(M) is unused (and thus available for use) because it is not being used for an optical link, whereas interfaces 40(1) and 40(2) are being used by optical links 30(1) and 30(2), respectively.

Depending on the type of router involved, the network management interface is a Command Line Interface (CLI), Simple Network Management Protocol (SNMP) or Extensible Markup Language (XML) interface. Furthermore, the cross-connect device 10 may be configured to register with the router 20 by sending a suitable message (e.g., query or registration request message) to cause the router to send to the cross-connect device 10 performance management (PM) notifications associated with the logical interface. For example, the cross-connect device 10 may register for PM notifications from the router, which notifications pertain to threshold crossing alarms associated with bandwidth utilization or queue build up, e.g., a bandwidth utilization threshold for a link bundle being exceeded, indicative of high bandwidth utilization, or conversely bandwidth utilization going below a bandwidth utilization, indicative of low bandwidth utilization.

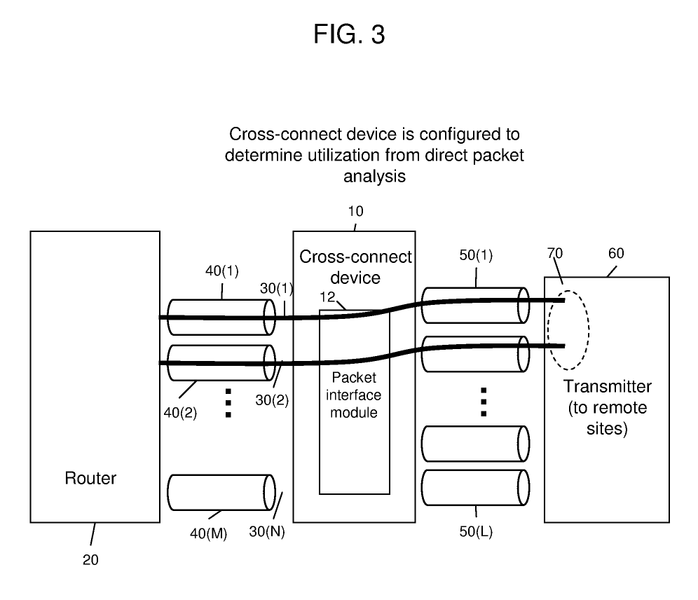

FIG. 3 illustrates a second way in which the cross-connect device 10 may be configured to monitor router utilization. In this technique, the cross-connect device 10 exploits awareness of packets obtained by a packet interface module 12 that exists in many cross-connect devices. That is, the cross-connect device keeps track of link bundle utilization by monitoring the packets of the traffic carried by the link bundle. The packet interface module 12 is used to separate packets on a single interface into separate logical or virtual links within a given optical link that are to be mapped to different optical transport network connections. One technique to distinguish between separate logical links or virtual interfaces is by virtual local area network (VLAN) tags in packets. Thus, the cross-connect device 10 can assess the bandwidth consumed by each logical link (and thus for an entire link bundle) directly without communicating with the router 20. In the example diagram shown in FIG. 3 (and like FIG. 2), the interface 40(M) is available for use because it is not being used for an optical link, whereas interfaces 40(1) and 40(2) are being used by optical links 30(1) and 30(2), respectively. This approach does not provide the same level of visibility that the approach shown in FIG. 2 provides since the traffic is already “shaped” by the router and therefore the queue may build up on the router, while the cross-connect device does not see any change in the traffic. However, this may be sufficient for many applications.

Furthermore, when the logical interface comprises a virtual interface that is a portion of a physical link interface, capacity may be adjusted by adjusting bandwidth for a physical link interface for the virtual interface based on the utilization.

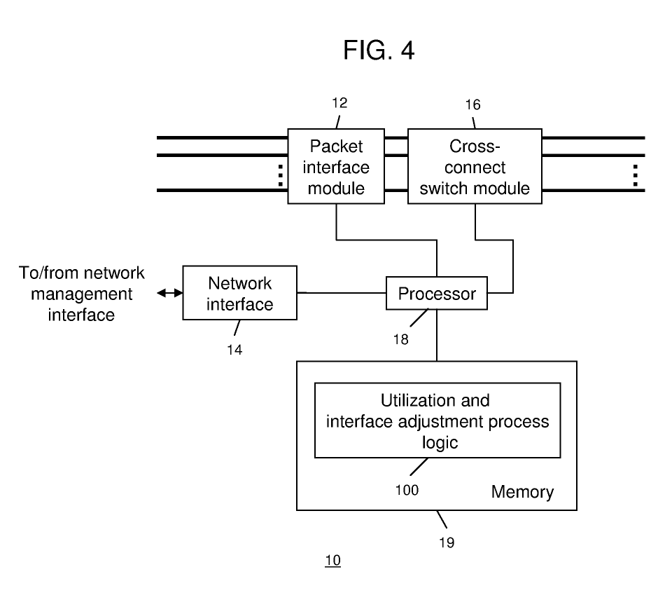

Reference is now made to FIG. 4. FIG. 4 illustrates an example of a block diagram of a cross-connect device 10 that is configured to monitor router utilization and to adjust the number of interfaces used accordingly. The cross-connect device 10 may comprise a packet interface module 12, whose functions are described above in connection with FIG. 3. The cross-connect device 10 may also comprise a network interface device 14 (e.g., Ethernet network card or unit) to facilitate communications via the aforementioned network management interface to the router and to cross-connect devices coupled to remote routers. Furthermore, the cross-connect device 10 comprises a cross-connect switch module 16, a processor 18 and memory 19. The memory 19 stores or is encoded with instructions for utilization and interface adjustment process logic 100. There may be other components in the cross-connect device 10 but those components are not shown in FIG. 4 for simplicity since they do not pertain to the techniques described herein.

The processor 18 may be a programmable processor or a fixed-logic processor. In the case of a programmable processor, the memory 19 is any type of tangible processor readable memory (e.g., random access, read-only, etc.) that is encoded with or stores instructions. For example, the processor 18 is a microprocessor or microcontroller. Alternatively, the processor 18 may a fixed-logic processing device, such as an application specific integrated circuit or digital signal processor, that is configured with firmware comprised of instructions that cause the processor 18 to perform the functions described herein. Thus, the process logic 100 may take any of a variety of forms, so as to be encoded in one or more tangible media for execution, such as with fixed logic or programmable logic (e.g., software/computer instructions executed by a processor) and the processor 18 may be a programmable processor, programmable digital logic (e.g., field programmable gate array) or an application specific integrated circuit (ASIC) that comprises fixed digital logic, or a combination thereof. In general, the process logic 100 may be embodied in a processor readable medium that is encoded with instructions for execution by a processor (e.g., processor 18) that, when executed by the processor, are operable to cause the processor to perform the functions described herein in connection with process logic 100.

The cross-connect switch module 16 may employ an optical-electrical-optical design that involves converting optical signals to electrical signals for switching, and then converting the electrical signals, after they are switched, back to optical signals for subsequent transmission in the optical network. In another form, the switch module 16 may employ an all optical approach in which the optical signals are switched by optical switch devices. Thus, the cross-connect device 10 may be an optical device or an optical-electrical device.

The cross-connect device need not have both the packet interface module 12 and the network interface device 14 in order to perform the router utilization monitoring techniques described herein. Only one of the packet interface module 12 and network interface device 14 is needed to support the router utilization techniques, and again, many cross-connect devices may already be designed to include one of these components, but not both. On the other hand, there may be cross-connect devices that include both of these components and such cross-connect devices could be configured to perform the packet monitoring techniques of FIG. 2 or FIG. 3, or both.

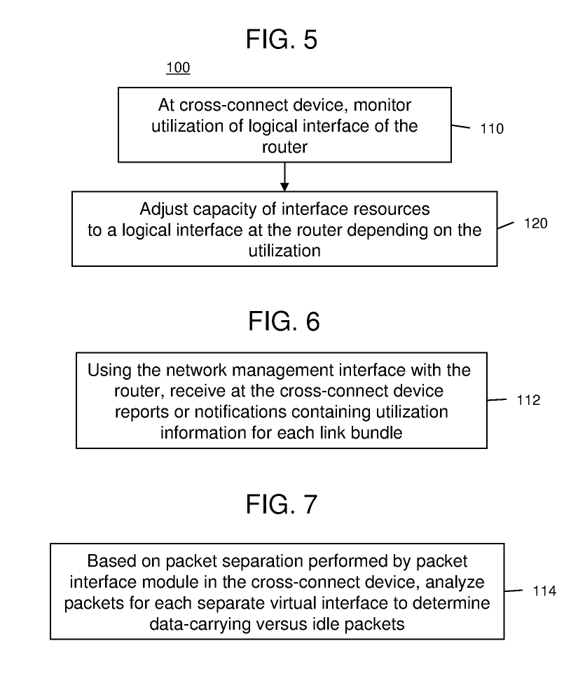

Turning now to FIG. 5, the process logic 100 is generally described. There are two basic functions of the process logic 100. The first function, shown at 110, involves the cross-connect device monitoring utilization of the logical interface of the router 20. Examples of techniques for monitoring link bundle utilization at the router are described above in connection with FIGS. 2 and 3 and are depicted again in FIGS. 6 and 7, respectively. The monitoring function 110 is performed on a periodic or on-demand basis, to obtain router utilization for at least one (or more generally for every) link bundle. For example, the monitoring function 110 is performed on a periodic basis as frequent as every few minutes or as less frequency as once every hour or few hours.

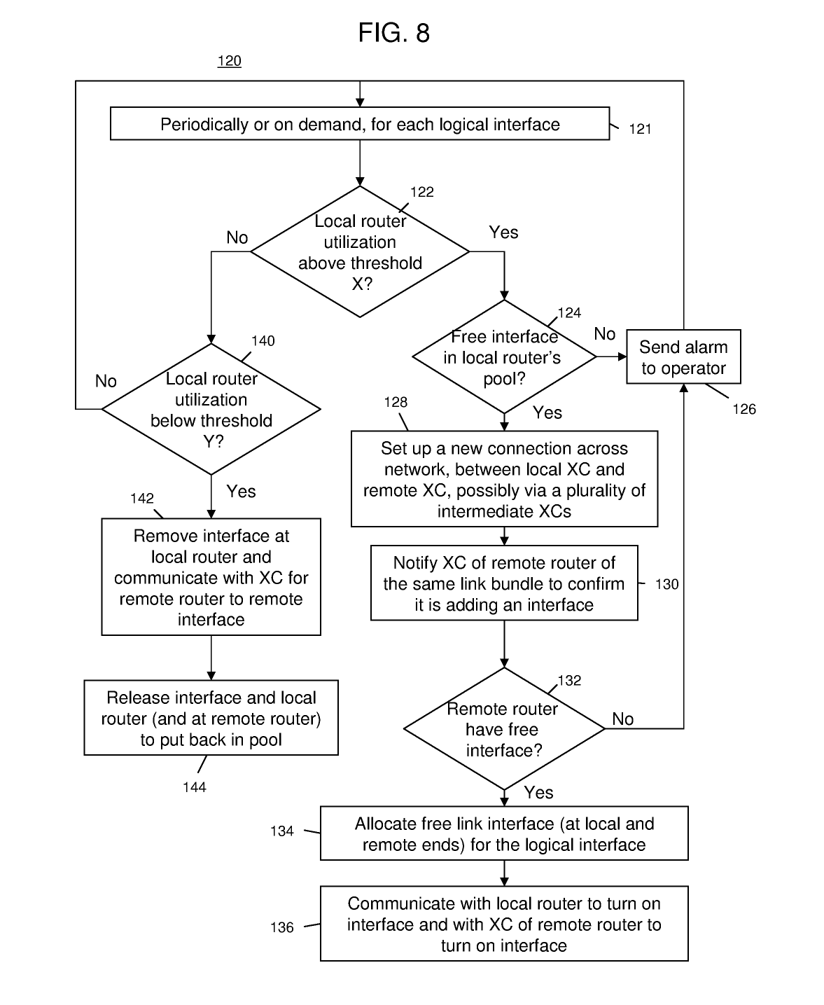

The second function is shown at 120 and involves adjusting capacity of interface resources (e.g., the number of link interfaces and bandwidth per link interface) used at the router depending on the utilization determined at 110. Generally, at 120, the cross-connect device assesses whether the current bandwidth needs of the logical interface exceeds a certain threshold (either absolute or as a percentage of the link bundle capacity) and determines whether bandwidth is to be added or removed for the logical interface. The function 120 is performed for at least one link bundle, but in general, for every link bundle of the router, and in the case of virtual interfaces, monitoring to determine utilization is performed for each virtual interface in a physical link. An example of the function 120 is described hereinafter in connection with FIG. 8.

Reference is now made to FIG. 6 for a description of the technique, referred to above in connection with FIG. 2, to monitor router utilization. As explained above, one technique, shown at reference numeral 112, is to use the network management interface between the cross-connect device and the router to receive from the router at the cross-connect device reports or notifications containing utilization information for the logical interface, e.g., each link bundle of the router. The various ways of obtaining the utilization information for each link bundle are described above in connection with FIG. 2.

FIG. 7 illustrates at 114 another technique for monitoring router utilization, where packet analysis is performed. In particular, based on the packet separation performed by the packet interface module in the cross-connect device, the cross-connect device analyzes packets for the logical interface (e.g., each separate virtual interface of a plurality of virtual interfaces) to determine data-carrying versus idle packets for each virtual interface. The cross-connects device generates a utilization measure for each logical or virtual interface that is derived from the number of packets that carry data versus the number of packets that are idle (do not carry data), i.e., a ratio of data-carrying packets or frames to idle frames, over a given period of time.

Reference is now made to FIG. 8 for a more detailed description of the adjusting function 120 shown in FIG. 5. Function 121 indicates that an evaluation session of functions 122-144 shown in FIG. 8 is performed periodically or on-demand, and during each evaluation session, the utilization of each logical interface at the router is evaluated until all logical interfaces (e.g., link bundle or virtual interfaces) have been evaluated. At 122, the cross-connect device compares the utilization of a logical interface, e.g., link bundle, of (i.e., local) router to determine whether it is above a first threshold, X. For example, the utilization may be measured in terms of bandwidth used by the link bundle (e.g., data rate) and the first threshold X is set to a bandwidth level that, when exceeded, indicates that additional bandwidth capacity should be allocated to the link bundle to maintain desired network performance. When the utilization of the logical interface is above the first threshold, then at 124, the cross-connect device determines whether there is an available (free) link interface in the pool of interfaces for the (local) router. When it is determined that there are no free interfaces available, then at 126, an alarm is generated and sent to a network operator so that some other adjustment can be made to account for the increased bandwidth that cannot be satisfied by assigning a new link interface to the logical interface. The process then returns to 121 for the next link bundle or the next evaluation session. On the other hand, when there is an available interface, then the process proceeds to 128.

At 128, the cross-connect device sets up a new connection for the logical interface across the network, between the cross-connect device (where the process 100 is being executed) and a cross-connect device for another router. The router of the cross-connect device where the process 100 is being executed is referred to as the “local” router and the cross-connect device coupled to the local router is referred to as the “local” cross-connect device. The router at the other end of the logical interface that is being evaluated for adjustment is referred to as the “remote” router. There is a cross-connect device for the remote router and it is referred to as a remote cross-connect device. There may be one or more intermediate cross-connect devices (and corresponding routers) in the path between the local cross-connect device and the remote cross-connect device. The remote cross-connect device need not be configured to perform the process 100 described herein; that is, only one cross-connect device for a link bundle needs to be configured to perform the process 100.

At 130, the local cross-connect device sends a notification (via the aforementioned network management interface) to the remote cross-connect device for the (same) logical interface, e.g., link bundle, under evaluation to confirm that it is adding an interface to that logical interface and to allocate available link resources to accommodate the new connection. The remote cross-connect device needs to add a link interface for the same logical interface to the remote router. The remote cross-connect device will send a message acknowledging that it has a free interface to add.

At 132, the local cross-connect device determines, based on receipt of an acknowledgment message to its notification sent at 130, whether the remote router has a free interface to add to the logical interface. When the local cross-connect device determines (by way of a suitable response message or lack of a response message from the remote cross-connect device) that the remote router does not have a free link interface to allocate to that logical interface, then the process goes to 126 to send a notification to a network operator. On the other hand, when the local cross-connect device determines (based on a proper response from the remote cross-connect device) that the remote router has an available link interface, the process proceeds to 134.

At 134, the local cross-connect device allocates a free link interface for the logical interface and the remote cross-connect device (in response to the message it received at 130) allocates at a free link interface at the other end to the logical interface. Then, at 136, the local cross-connect device communicates with the local router to turn on (or otherwise activate) the available link interface to the logical interface and sends a message to the remote cross-connect device to command the remote router to activate an available link interface to the logical interface. If the case where the logical interface is a virtual interface that is a portion of a physical link interface, then, the activation message includes information to change (increase) the bandwidth of a physical link interface allocated for the virtual interface, which affects the shaping and policing of traffic to fit the new bandwidth allocation for the link. At this point, a link interface has been added by the routers at both ends of the logical interface, and the bandwidth capacity of the link bundle has been increased by the bandwidth capacity of the newly added link to the logical interface.

Conversely, when local cross-connect device determines at 122 that the local router utilization for the logical interface under evaluation is not above the first threshold X, then the process proceeds to 140. At 140, the local cross-connect device determines whether utilization of the link bundle at the router is less than a second threshold, Y. When it is determined at 140 that the utilization of the bundle is not below the second threshold Y, then the process returns to 121 for the next link bundle or waits for the next evaluation session if all logical interfaces have been evaluated in this session.

When the local cross-connect device determines that utilization of the logical interface under evaluation is less than the second threshold (i.e., the logical interface is under utilized), then at 142, the local cross-connect device removes interface resources from that logical interface at the local router or reduces the bandwidth in a physical link interface allocated for a virtual interface and communicates with the remote cross-connect for a remote router for that link bundle to notify it to also remove an interface for that logical interface or reduce the bandwidth for a virtual interface. As indicated at 127, the process then repeats for the next logical interface.

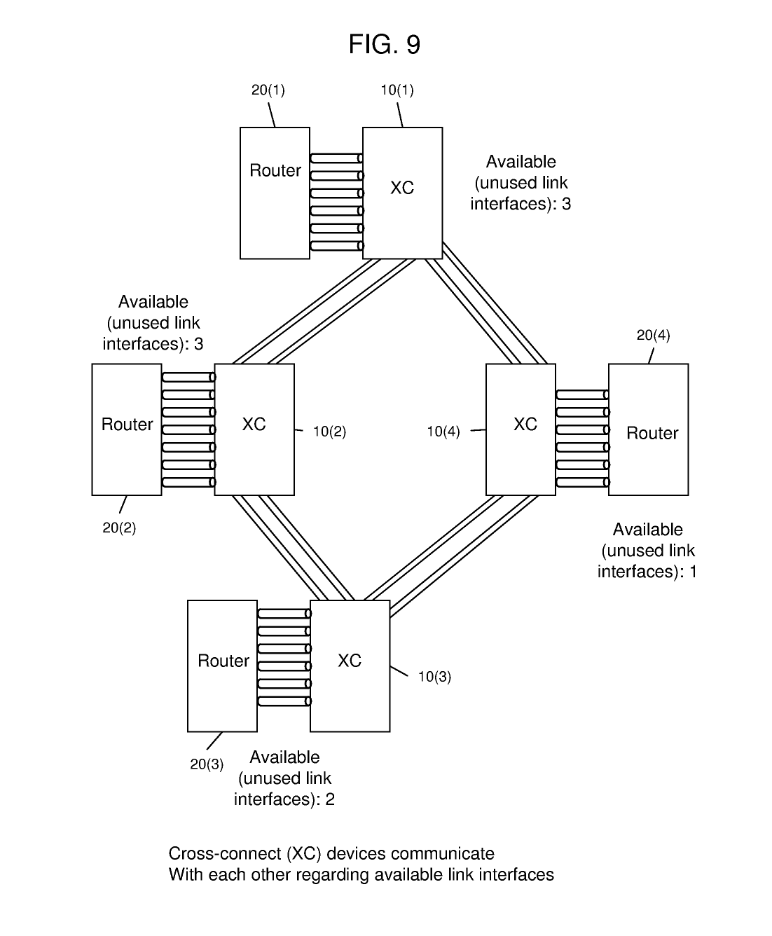

Reference is now made to FIGS. 9-11 for a description of an example scenario where a cross-connect device, configured as described herein in connection with FIGS. 1-8, to dynamically adjust link interface resources of a router based on link bundle utilization. FIG. 9 shows an example where there are four cross-connect devices 10(1), 10(2), 10(3) and 10(4), configured to couple to routers 20(1), 20(2), 20(3) and 20(4), respectively. There are a plurality of link interfaces shown between each cross-connect device and the router. For simplicity, these link interfaces are not specifically identified by a reference numeral. The number of link interfaces between a cross-connect device and the router is not the same for all cross-connect devices. Moreover, at a given instant of time, the number of unused (available) link interfaces for each router is not necessarily the same across all routers. For example, cross-connect device 10(1) determines that there are 3 unused interfaces at its router 20(1), cross-connect device 10(2) determines that there are 3 unused interface at its router 20(2), cross-connect device 10(3) determines that there are 2 unused interfaces at its router 20(3) and cross-connect device 10(4) determines that there is one unused interface at its router 20(4). For simplicity, FIG. 9 illustrates only some, but not all, link bundles between cross-connect devices.

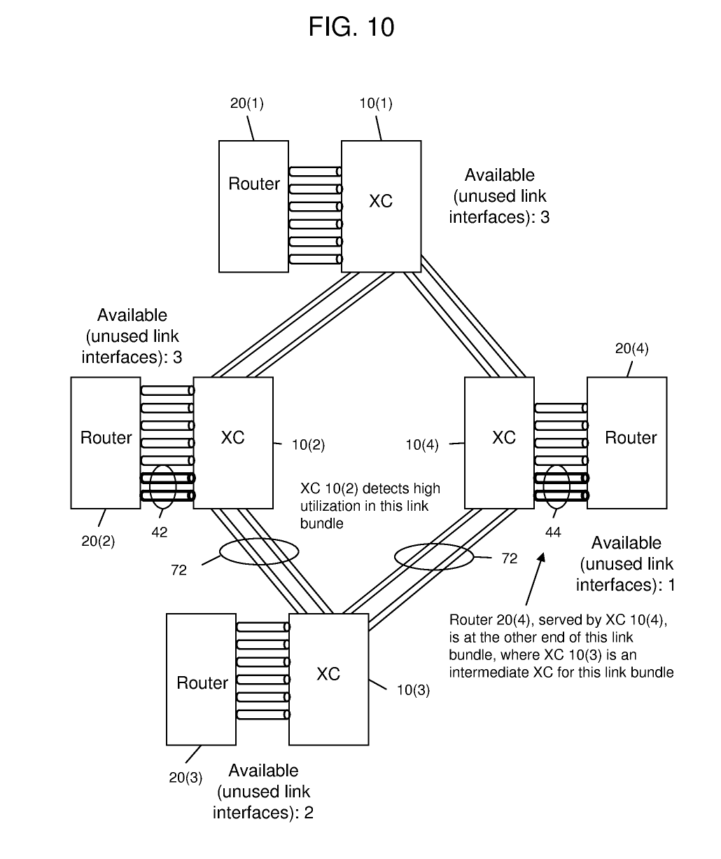

FIG. 10 illustrates a change in utilization at some point in time later than that depicted in FIG. 9. In particular, in FIG. 10, cross-connect 10(2) detects high utilization in link bundle 72 that it is serving for router 20(2). The other end of link bundle 72 is at router 20(4) that is served by cross-connect device 10(4). Moreover, the link bundle 72 passes through an intermediate cross-connect device 10(3). As shown at 42, there are two link interfaces at router 20(2) that have already been allocated to serve the link bundle 72 and there are two link interfaces shown at 44 of router 20(4) that have already been allocated to serve link bundle 72. Cross-connect device 10(2), by executing the process logic 100 described herein, determines that the utilization of link bundle 72 exceeds a threshold (e.g., the first threshold X depicted in FIG. 8), and that there are 3 available link interfaces at the router 20(2) and one available interface at the router 20(4) at the other end of the link bundle 72. The cross-connect device 10(2) determines to increase the number of link interfaces used to serve the link bundle 72 (at both ends of the link bundle 72).

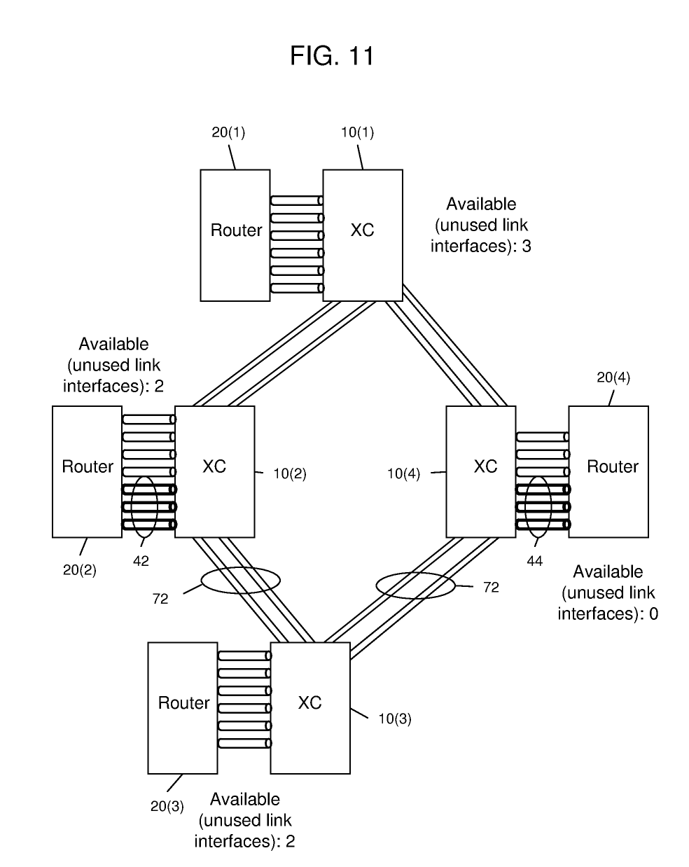

FIG. 11 shows the state of the network arrangement after the cross-connect 10(2) makes the change to the link interfaces used for the link bundle 72. The cross-connect device 10(2) adds a link interface at router 20(2) for link bundle 72 and causes the cross-connect device 10(4) to add a link interface at router 20(4) for link bundle 72. After this change, as shown at reference numeral 42 there are 3 link interfaces at router 20(2) for link bundle 72 and as shown at reference numeral 44 there are 3 link interfaces at router 20(4) for link bundle 72. Due to this allocation of one additional link interface at routers 20(2) and 20(4) to accommodate the increased utilization of link bundle 72, there are 2 available link interfaces at router 20(2) and no available link interfaces at router 20(4).

The link interfaces for a router may have different bandwidth capacities than other link interfaces for the same router. Therefore, when adding a new link interface or removing a link interface, the cross-connect device may send an appropriate command to the router to select the link interface with the smallest or largest capacity when adding or removing a link interface. There are other considerations that may factor in the decision to select a specific link in a bundle, such as the need to keep the active links distributed over different router line cards so that a card failure will not affect most of the bundle.

The techniques described herein allow for dynamically adjusting to changes in traffic that are temporary (e.g., temporary surges), periodic (shifts such as day-night traffic pattern variations) and sudden (unexpected traffic growth due to newly activated high-volume web site server). Furthermore, these techniques do not require a specialized signaling mechanism between the cross-connect device and the router. Either an existing network management interface is used or the cross-connect device examines packets to assess utilization of a link bundle.

Thus, provided herein is a method comprising at a cross-connect device configured to be coupled to a router, monitoring utilization of a logical interface of the router; and adjusting capacity of interface resources to the logical interface at the router depending on the utilization.

Likewise, an apparatus is provided comprising a cross-connect switch module configured to switch signals of a logical interface of a router; and a processor configured to be coupled to the cross-connect switch module. The processor is configured to monitor utilization of the logical interface, and adjust capacity of interface resources at the router for the logical interface depending on the utilization.

Further still, a processor readable medium is provided that is encoded with instructions that, when executed by a processor, cause the processor to, at a cross-connect device configured to couple to a router, monitor utilization of a logical interface of the router, and adjust capacity of interface resources to the logical interface at the router depending on the utilization.

The above description is by way of example only.

What is claimed is:

1. A method comprising:
at a cross-connect device configured to be coupled to a router, monitoring utilization of a logical interface of the router; and
adjusting capacity of interface resources to the logical interface at the router depending on the utilization.

2. The method of claim 1, wherein the logical interface comprises a link bundle, and wherein adjusting comprises adding for use or removing from use a physical link interface for the link bundle depending on the utilization.

3. The method of claim 1, wherein the logical interface comprises a virtual interface which is a portion of a physical link interface, and wherein adjusting comprises adjusting bandwidth in a physical link interface for the virtual interface based on the utilization.

4. The method of claim 1, wherein adjusting comprises determining when utilization of the logical interface is above a threshold and in response communicating with a cross-connect device for a remote router to set up a new connection and to allocate available link interface resources to accommodate the new connection.

5. The method of claim 1, wherein adjusting comprises determining when utilization of the logical interface is below a threshold and in response removing from use interface resources at the router and communicating with a cross-connect device for a remote router to remove from use interface resources at the remote router.

6. The method of claim 1, wherein monitoring comprises receiving bandwidth utilization statistics for the logical interface at the cross-connect device from the router via a network management interface between the router and the cross-connect device, wherein the bandwidth utilization statistics comprise one or more of number of packets transmitted, average size of a packet and total bandwidth consumed.

7. The method of claim 1, wherein monitoring comprises sending a message to the router to cause the router to send to the cross-connect device performance management notifications associated with the logical interface.

8. The method of claim 1, wherein monitoring comprises analyzing at the cross-connect device packets in the logical interface of the router to determine a measure of packets that contain data and packets that do not contain data.

9. The method of claim 8, wherein the logical interface comprises a plurality of virtual interfaces each for a portion of a physical link interface, and further comprising distinguishing between separate virtual interfaces, and wherein monitoring comprises determining the measure of packets that contain data and packets that do not contain data for each virtual interface.

10. An apparatus comprising:
a cross-connect switch module configured to switch signals of a logical interface of a router; and
a processor configured to be coupled to the cross-connect switch module, and configured to:
monitor utilization of the logical interface; and
adjust capacity of interface resources at the router for the logical interface depending on the utilization.

11. The apparatus of claim 10, and further comprising a network interface device that is configured to enable network communications with the router, and wherein the processor is configured to monitor utilization of the logical interface by receiving bandwidth utilization statistics for the logical interface from the router via a management interface with the router, wherein the bandwidth utilization statistics comprise one or more of number of packets transmitted, average size of a packet and total bandwidth consumed.

12. The apparatus of claim 11, wherein the processor is further configured to send a message to the router via the network interface device, wherein the message is configured to cause the router to send performance management notifications for the logical interface.

13. The apparatus of claim 10, and further comprising a packet interface module that is configured to separate packets in the logical interface into separate virtual interfaces, and wherein the processor is configured to determine the utilization of the virtual interfaces by determining, based on packets separated by the packet interface module, a measure of packets that contain data and packets that do not contain data.

14. The apparatus of claim 10, wherein the logical interface comprises a link bundle at the router, and wherein the processor is further configured to generate a command to add for use or remove from use a physical link interface for the link bundle at the router depending on the utilization.

15. The apparatus of claim 10, wherein the logical interface comprises a virtual interface that is a portion of a physical link interface, and wherein the processor is further configured to adjust bandwidth in a physical link interface for the virtual interface based on the utilization.

16. A processor readable medium encoded with instructions that, when executed by a processor, cause the processor to:
at a cross-connect device configured to be coupled to a router, monitor utilization of a logical interface of the router; and
adjust capacity of interface resources to the logical interface at the router depending on the utilization.

17. The processor readable medium of claim 16, wherein the instructions that cause the processor to monitor comprise instructions that cause the processor to receive bandwidth utilization statistics for the logical interface at the cross-connect device from the router via a network management interface between the router and the cross-connect device, wherein the bandwidth utilization statistics comprise one or more of number of packets transmitted, average size of a packet and total bandwidth consumed.

18. The processor readable medium of claim 16, wherein the instructions that cause the processor to monitor comprise instructions that cause the processor to generate a message to be sent to the router, wherein the message is configured to cause the router to send to the cross-connect device performance management notifications associated with the logical interface.

19. The processor readable medium of claim 16, wherein the instructions that cause the processor to monitor comprise instructions that cause the processor to analyze packets in the logical interface to determine a measure of utilization of the logical interface based on packets determined to contain data and packets determined not to contain data.

20. The processor readable medium of claim 16, wherein the logical interface comprises a link bundle, and wherein the instructions that cause the processor to adjust comprise instructions that cause the processor to add for use or remove from use a physical ink interface at the router for the link bundle depending on the utilization.

21. The processor readable medium of claim 16, wherein the logical interface comprises a virtual interface that is a portion of a physical link interface, wherein the instructions that cause the processor to adjust comprise instructions that cause the processor to adjust bandwidth in a physical link interface to the virtual interface based on the utilization.
